(19) United States
(12) Patent Application Publication
(10) Pub. No.: US 2010/0028513 A1
(43) Pub. Date: Feb. 4, 2010

(54) Unpeeled orange fruit, with its rind dried up before overriping

(76) Inventor: Edilberto Balce, Long Beach, CA (US)

Correspondence Address: Edilberto R. Balce, Apt. 299, #3188 Springdale Drive, Long Beach, CA, 90810, US

(21) Appl. No.: 12/152,901

(22) Filed: Aug. 1, 2008

(51) Int. Cl. A23L 1/212

(52) U.S. Cl. 426/419

(57) ABSTRACT

Prolonged preservation of the orange fruit, easier wrapping, packing, storage, processing and transport without need for expensive refrigeration would necessarily facilitate transport and exportation; and vastly increase the material and moral well-being of the persons involved in the business, including the producers, the workers and consumers.

An unpeeled orange fruit, with its rind dried up before overriping.

This is achieved by constant exposure of the outermost cover to the air, unhindered by sufficiently air-obstructing wrapping, packaging, container or storage. The drying up process lasts anywhere from one to ninety days depending on atmospheric conditions like temperature, humidity and speed of air circulation, as well as the thickness of the rind and outermost cover, in addition to the level of maturity of the fruit upon date of harvest. Drying up can be enhanced, facilitated and sped up with the use of sunlight and/or similar drying aids, necessarily with care to prevent overriping. The drying up process is intended to facilitate sweetness and lighten the fruit for the sake of lighter transport and preservation with little or no refrigeration; in addition to facilitating juicing, peeling and disposal of undesirable portions.

The meat is easier to eat. All one has to do is to cut—preferably in at least three parts of equal sizes and shapes—the unpeeled fruit, and bite the meat away from the coating The previously foul tasting rind has shrank, become tasteless, and virtually detached from the edible portions.

The invention could hopefully enhance exportation and uplift the income, morale and the general well-being of the millions of people whose lives are affected by the industry, in addition to the economic welfare of the country.

1. The first named inventor hereby claims that as a notorious fact, molds, mostly white or grey colored, is the most common type of decay-agents that initiates and otherwise causes decay of oranges, other edible fruits, and many other foodstuffs. Molds attack and thrive faster and more efficiently in damp surfaces like the outermost coating and rind of newly harvested oranges. To prevent this imminent attack on the newly harvested fruit, the latter should be exposed to free flowing air, preferably aided by sunlight or similar sources of heat.
The foregoing procedure would slow down molding and the imminent decay of the fruit, as well as reduce its water content. The rind will get thinner and easier to peel. Drying of the rind detaches it from the meat. Thus it becomes relatively easier to peel away. Before drying, peeling of the rind undesirably tends to get part of the meat peeled also. The meat tastes better when eaten without part of the rind.
The total weight of the fruit and coating will be reduced such that it is easier to carry, wrap, package, store and transport especially in large volumes. Evaporation of the water content will leave the fruit's edible portion sweeter. This, because the fruit's sugar content percentage tends to grow higher. The California orange shall have lived up to its world-wide fame as the world's sweetest.
The fruit is easier to juice because the rind shall have grown tougher. The juicing hand easily detects when the juicing implement is about to stab the juiceless rind past the juice-containing meat.
